(19) United States
(12) Patent Application Publication
(10) Pub. No.: US 2008/0131586 A1
(43) Pub. Date: Jun. 5, 2008

(54) Method for Manufacturing Fuel Cell and Apparatus for Manufacturing Fuel Cell

(76) Inventor: Yuichiro Hama, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/795,558

(22) PCT Filed: Feb. 1, 2006
(86) PCT No.: PCT/JP06/02108

§ 371 Date: Jul. 18, 2007

(30) Foreign Application Priority Data
Feb. 1, 2005 (JP) 2005-025629

(51) Int. Cl. B05D 1/02; B05C 5/00

(52) U.S. Cl. 427/58; 118/58

(57) ABSTRACT

A method for manufacturing a cylindrical fuel cell having a first catalyst layer, an electrolyte layer and a second catalyst layer, comprising forming the first catalyst layer on the outer surface of a cylindrical support by a spraying method, forming the electrolyte layer on the first catalyst layer by a spraying method, and forming the second catalyst layer on the electrolyte layer by a spraying method, wherein each of the forming is conducted in a continuous manner. An apparatus for manufacturing a fuel cell is also disclosed.

### TECHNICAL FIELD

The present invention relates to a method for manufacturing a fuel cell and an apparatus for manufacturing a fuel cell, and relates more particularly to a method for manufacturing, and an apparatus for manufacturing, a cylindrical fuel cell.

### BACKGROUND ART

Fuel cells, which generate electricity by converting chemical energy to electrical energy via an electrochemical reaction that uses, as raw materials, an oxidizing gas such as oxygen or air, and a reducing gas (a fuel gas) such as hydrogen or methane or a liquid fuel such as methanol are attracting considerable attention as one possible countermeasure to environmental problems and resource problems. In a fuel cell structure, a fuel electrode (an anode catalyst layer) provided on one surface of an electrolyte film and an air electrode (a cathode catalyst layer) provided on the other surface are disposed facing one another across the electrolyte film, a diffusion layer is provided on the outside of each of these catalyst layers that sandwich the electrolyte film, and these diffusion layers are then sandwiched between separators that include raw material supply passages, and electricity is then generated by supplying the raw materials such as hydrogen and oxygen to each of these catalyst layers.

During power generation using a fuel cell, if the raw material supplied to the fuel electrode is hydrogen gas and the raw material supplied to the air electrode is air, then at the fuel electrode, hydrogen ions and electrons are generated from the hydrogen gas. These electrons pass from an external terminal, and through an external circuit, before reaching the air electrode. At the air electrode, the oxygen within the supplied air, the hydrogen ions that have passed through the electrolyte film, and the electrons that have traveled through the external circuit to reach the air electrode react together to generate water. In this manner, chemical reactions occur at both the fuel electrode and the air electrode, and an electrical charge is generated, enabling the structure to function as an electric cell. Because the raw material gases and/or liquid fuels used for power generation are abundant, and the material discharged as a result of the power generation is water, this type of fuel cell is being investigated as a potential clean energy source for all manner of applications.

Tubular fuel cells (solid circular cylindrical, hollow circular cylindrical, and hollow fuel cells) are conventional examples of this type of fuel cell (for example, see Japanese Patent Laid-Open Publication No. 2002-124273, Japanese Patent Laid-Open Publication No. 2002-289220, Japanese Patent Laid-Open Publication No. 2002-260685). Tubular fuel cells have a structure in which the fuel electrode is provided on either the inner or outer surface of a tubular polymer electrolyte film, and the air electrode is provided on the other surface, and offer the advantage of being able to be more easily reduced in size than flat fuel cells. The assembly (air electrode/electrolyte film/fuel electrode) used in a tubular fuel cell is typically formed by an extrusion molding method (see Japanese Patent Laid-Open Publication No. 2002-124273), immersion method (see Japanese Patent Laid-Open Publication No. 2002-289220), or chemical plating method (Japanese Patent Laid-Open Publication No. 2002-260685), so that catalyst layers (the fuel electrode and the air electrode) are formed on the inner and outer surfaces of the tubular electrolyte film.

In an extrusion molding method such as that disclosed in Japanese Patent Laid-Open Publication No. 2002-124273, a catalyst for the fuel electrode, a solid electrolyte polymer for the electrolyte film, and a catalyst for the air electrode are each converted to a flowable fluid form using an appropriate solvent, and the assembly is then obtained by conducting an integrated extrusion molding process that generates, in sequence from the inside out, a layer of each of the fuel electrode catalyst, the solid electrolyte polymer, and the air electrode catalyst. By extruding each of the fluids from an extrusion nozzle, an integrated molded product is obtained, and the multilayered assembly is then solidified by heating the molded product to volatilize the solvents.

In an immersion method such as that disclosed in Japanese Patent Laid-Open Publication No. 2002-289220, a hollow porous support is immersed in a treatment tank filled with a resin solution (a paste) containing the catalyst for the air electrode, and is then removed and dried to form a catalyst layer (the air electrode). A similar process is then used to form an electrolyte layer and another catalyst layer (the fuel electrode), thereby completing the assembly.

In a chemical plating method such as that disclosed in Japanese Patent Laid-Open Publication No. 2002-260685, chemical plating is used to form a catalyst layer (the air electrode) on the outer surface of a tubular electrolyte film by bringing an aqueous solution of the catalyst for the air electrode into contact with the tubular electrolyte film, the entire tube is then washed, and a mixture containing the catalyst for the fuel electrode in suspension form is then injected inside the tube, thereby forming another catalyst layer (the fuel electrode) and completing the assembly.

On the other hand, Japanese Patent Laid-Open Publication No. 2003-100314 discloses a method for manufacturing a fuel cell comprising a fuel electrode on one surface of a flat polymer electrolyte film and an air electrode on the other surface, wherein the catalyst layers are formed by spraying, with heating, a resin solution slurry containing the catalyst dispersed therein onto the surface of the flat polymer electrolyte film. This spray method enables the manufacture of an assembly in which the catalyst layers have been formed with good uniformity.

Furthermore, Japanese Patent Laid-Open Publication No. H06-29031 discloses a method for manufacturing a circular cylindrical solid electrolyte fuel cell, comprising forming an electrolyte molding by pouring a slurry containing a solid electrolyte into a molding die that is water-absorbent and is partially fitted with a waterproof or water-repellent member, removing the waterproof or water-repellent member and subsequently pouring a catalyst-containing slurry into the molding die to form a fuel electrode, applying or spraying a slurry onto the exposed portion of the fuel electrode formed by removal of the waterproof or water-repellent member, thereby forming an interconnector, conducting baking, and then forming an air electrode on the outside of the solid electrolyte film by an immersion method, thereby completing the assembly.

Furthermore, Japanese Patent Laid-Open Publication No. H06-72787 discloses a method for manufacturing a circular cylindrical solid electrolyte fuel cell, comprising forming an air electrode and a solid electrolyte layer on the surface of a circular cylindrical support, spraying a resin solution slurry containing a dispersed catalyst onto the structure, conducting drying and baking, and then forming a fuel electrode by using an immersion method to form a surface layer of a compound oxide, thereby completing the assembly.

### DISCLOSURE OF THE INVENTION

However, in an extrusion molding method such as that disclosed in Japanese Patent Laid-Open Publication No. 2002-124273, when the fluids containing the catalyst for the fuel electrode, the solid electrolyte polymer for the electrolyte film, and the catalyst for the air electrode respectively are subjected to integrated extrusion molding, there is a possibility that the fluids may become mixed together, meaning it is difficult to obtain an assembly with uniform film thickness for each of the layers.

Furthermore, in an immersion method such as that disclosed in Japanese Patent Laid-Open Publication No. 2002-289220, although the liquid properties such as the viscosity vary between the catalyst pastes and the electrolyte film paste, the travel speed of the support must be held at a constant level during the consecutive formation of the catalyst layer, electrolyte layer, and catalyst layer that yields the tubular assembly. As a result, the coating conditions cannot be optimized for each of the various pastes, which makes continuous production difficult. Furthermore, in an immersion method, because the support is immersed directly in, and then removed from, the material solutions, the catalyst layers are also formed in locations where these layers are unnecessary (such as the edges of the support), and these unnecessary portions of the catalyst layers must be removed in subsequent steps.

Furthermore, in a chemical plating method such as that disclosed in Japanese Patent Laid-Open Publication No. 2002-260685, continuous production of a cylindrical assembly is difficult.

Moreover, in the method disclosed in Japanese Patent Laid-Open Publication No. 2003-100314, although a flat assembly can be produced, obtaining a cylindrical assembly in a continuous manner is difficult.

Furthermore, in the case of the methods disclosed in Japanese Patent Laid-Open Publication No. H06-29031 and Japanese Patent Laid-Open Publication No. H06-72787, the process is complex, and producing a cylindrical assembly in a continuous manner is problematic.

The present invention provides a method and an apparatus for manufacturing a cylindrical fuel cell having a first catalyst layer, an electrolyte layer and a second catalyst layer, wherein the film thickness uniformity of the first catalyst layer, the electrolyte layer and the second catalyst layer is favorable, and each of the layers can be formed in a continuous manner.

The present invention also provides a method for manufacturing a cylindrical fuel cell having a first catalyst layer, an electrolyte layer and a second catalyst layer, comprising forming the first catalyst layer on the outer surface of a cylindrical support by a spraying method, forming the electrolyte layer on the first catalyst layer by a spraying method, and forming the second catalyst layer on the electrolyte layer by a spraying method, wherein each of the forming is conducted in a continuous manner.

Furthermore, the above method for manufacturing a fuel cell preferably further comprises drying the formed first catalyst layer following the forming the first catalyst layer, drying the formed electrolyte layer following the forming the electrolyte layer, and drying the formed second catalyst layer following the forming the second catalyst layer, wherein each of the forming and drying is conducted in a continuous manner.

Furthermore, in the above method for manufacturing a fuel cell, the spraying method is preferably conducted by spraying a paste onto a plurality of locations on the outer surface of the cylindrical support.

Furthermore, in the above method for manufacturing a fuel cell, the cylindrical support with each of the layers formed thereon is preferably cut to yield a plurality of fuel cell single cells.

Furthermore, in the above method for manufacturing a fuel cell, the cylindrical support is preferably a conductive porous member.

The present invention also provides an apparatus for manufacturing a cylindrical fuel cell having a first catalyst layer, an electrolyte layer and a second catalyst layer, wherein the apparatus comprises a transport unit that transports a cylindrical support, a first spray unit that sprays a paste for the first catalyst layer onto the outer surface of the cylindrical support to form the first catalyst layer, a first drying unit that dries the formed first catalyst layer, a second spray unit that sprays a paste for the electrolyte layer onto the dried first catalyst layer to form the electrolyte layer, a second drying unit that dries the formed electrolyte layer, a third spray unit that sprays a paste for the second catalyst layer onto the dried electrolyte layer to form the second catalyst layer, and a third drying unit that dries the formed second catalyst layer.

Furthermore, each of the spray units within the above apparatus for manufacturing a fuel cell preferably comprises a plurality of sprayers.

Furthermore, in the above apparatus for manufacturing a fuel cell, the cylindrical support is preferably a conductive porous member.

In a method for manufacturing a cylindrical fuel cell having a first catalyst layer, an electrolyte layer and a second catalyst layer according to the present invention, by conducting the film formation in a continuous manner, wherein each formation involves conducting spraying onto the outer surface of a cylindrical support, the first catalyst layer, the electrolyte layer and the second catalyst layer can be produced in a continuous manner, with favorable film thickness uniformity for each layer.

### BRIEF DESCRIPTION OF THE DRAWINGS

FIG. 1 is a diagram showing an example of the structure of a fuel cell according to an embodiment of the present invention.

FIG. 2 is a diagram showing an example of an apparatus for manufacturing a fuel cell according to an embodiment of the present invention.

FIG. 3 is a diagram showing one example of a method for obtaining single cells by cutting a fuel cell obtained from a method for manufacturing a fuel cell according to an embodiment of the present invention.

FIG. 4 is a diagram showing the positioning of sprayers in a method for manufacturing a fuel cell according to an embodiment of the present invention.

### BEST MODE FOR CARRYING OUT THE INVENTION

As follows is a description of a fuel cell manufactured using a method and apparatus for manufacturing a fuel cell according to an embodiment of the present invention.

A fuel cell according to an embodiment of the present invention comprises a first catalyst layer, an electrolyte layer, and a second catalyst layer.

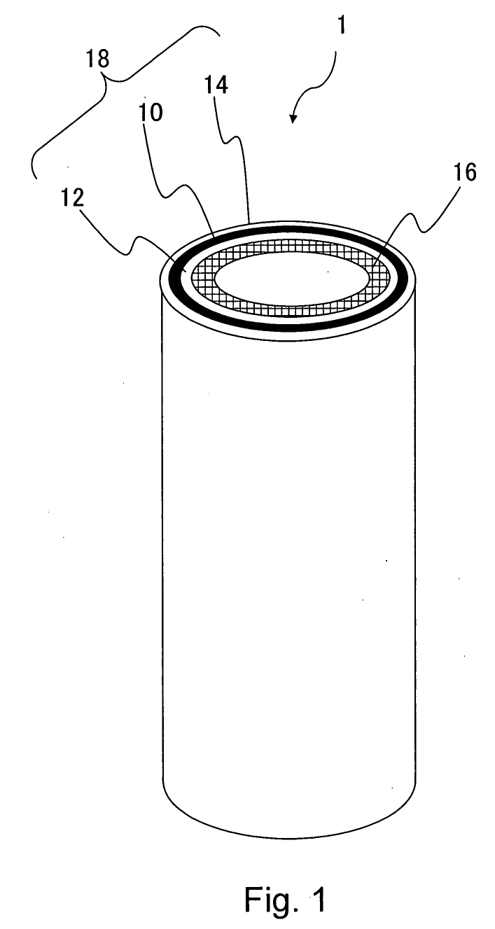

FIG. 1 shows an outline of one example of a fuel cell 1 according to an embodiment of the present invention. The structure of this fuel cell 1 is described below. The fuel cell 1 comprises an electrolyte layer 10, a first catalyst layer that functions as a fuel electrode (an anode catalyst layer) 12, a second catalyst layer that functions as an air electrode (a cathode catalyst layer) 14, and a current collecting member 16. Furthermore, an additional current collecting layer may also be formed on the outer surface of the air electrode 14 of the second catalyst layer.

In the fuel cell 1 shown in FIG. 1, the fuel electrode 12 that acts as the first catalyst layer is provided on the outer surface of the circular cylindrical support that functions as the current collecting member 16, the electrolyte layer 10 is provided on the outer surface of the fuel electrode 12, and the air electrode 14 that acts as the second catalyst layer is provided on the outer surface of the electrolyte layer 10, thus forming a cylindrical assembly (MEA: Membrane Electrode Assembly) 18. In an alternative structure of the fuel cell 1, an air electrode 14 that acts as the first catalyst layer may be formed on the outer surface of the cylindrical current collecting member 16, with the electrolyte layer 10 then provided on the outer surface of the air electrode 14, and a fuel electrode 12 that acts as the second catalyst layer provided on the outer surface of the electrolyte layer 10. However, the fuel electrode 12 is usually provided as the first catalyst layer, with the air electrode 14 provided as the second catalyst layer.

In this type of fuel cell 1, if either the current collecting member 16 and the air electrode 14 of the second catalyst layer, or the current collecting member 16 and the current collecting layer formed on the outer surface of the air electrode 14 of the second catalyst layer are connected electrically to an external circuit, and operation is then commenced by supplying raw materials to the fuel electrode 12 and the air electrode 14, this structure can be operated as a fuel cell.

There are no particular restrictions on the electrolyte layer 10, provided it is formed from a material that exhibits high ion conductivity for ions such as protons (H⁺) and oxygen ions (O²⁻). Suitable materials include solid polymer electrolyte films and stabilized zirconia films, although the use of solid polymer electrolyte films such as perfluorosulfonic acid-based films is preferred. Specific examples of the materials that can be used include perfluorosulfonic acid-based solid polymer electrolyte films such as Goreselect (a registered trademark) manufactured by Japan Goretex Inc., Nafion (a registered trademark) manufactured by DuPont Corporation, Aciplex (a registered trademark) manufactured by Asahi Kasei Corporation, or Flemion (a registered trademark) manufactured by Asahi Glass Co., Ltd. The film thickness of the electrolyte layer 10 is typically within a range from 10 to 200 μm, and is preferably from 30 to 50 μm.

The fuel electrode 12 is formed, for example, from a film produced by dispersing a catalyst, such as carbon with platinum (Pt) and another metal such as ruthenium (Ru) supported thereon, within a resin such as a solid polymer electrolyte like Nafion (a registered trademark). The film thickness of the fuel electrode 12 is typically within a range from 1 to 100 μm, and is preferably from 1 to 20 μm.

The air electrode 14 is formed, for example, from a film produced by dispersing a catalyst, such as carbon with platinum (Pt) supported thereon, within a resin such as a solid polymer electrolyte like Nafion (a registered trademark). The film thickness of the air electrode 14 is typically within a range from 1 to 100 μm, and is preferably from 1 to 20 μm.

In this embodiment, there are no particular restrictions on the current collecting member 16 that functions as the circular cylindrical support on which the electrolyte layer 10, the fuel electrode 12, and the air electrode 14 are formed, provided the member is formed from a highly conductive material that allows the transmission of electrons during power generation within the assembly. In order to function as a supply passage that facilitates diffusion of the raw materials such as the fuel gas, the current collecting member 16 is preferably formed from a conductive porous material such as a powder sintered compact, a fiber sintered compact, or a fiber foam. Examples of suitable highly conductive materials include porous members of conductive materials, including metals such as gold and platinum, carbon, and titanium or carbon that has been surface-coated with a metal such as gold or platinum; as well as cylindrical hollow members of the above materials in which a process such as punching has been used to provide holes in the walls of the cylinder. Of these materials, from the viewpoints of properties such as conductivity, raw material diffusion and corrosion resistance, a porous carbon material is preferred. In those cases where the current collecting member 16 is a hollow member, the film thickness of the member is typically within a range from 0.5 to 10 mm, and is preferably from 1 to 3 mm. If the current collecting member 16 is a solid member, then the film thickness is typically within a range from 0.5 to 10 mm, and is preferably from 1 to 3 mm.

In those cases where a process such as punching is used to provide holes in the walls of a hollow cylindrical current collecting member 16, the diameter of those holes is typically within a range from 0.01 to 1 mm.

Although the current collecting member 16 described above is used as a cylindrical support in this embodiment, the present invention is not limited to such structures, and for example, circular column-shaped supports such as a rod or wire formed from a resin with favorable releasability such as Teflon (a registered trademark), or a metal rod or wire coated with a resin with favorable releasability such as Teflon (a registered trademark) may also be used instead of the current collecting member 16. In such cases, following formation of the assembly 18, the completed assembly 18 should be removed from the support.

The cylindrical support may be any cylindrical shape, including a circular cylinder; a polygonal cylinder such as a triangular cylinder, square cylinder, pentagonal cylinder or hexagonal cylinder; or an elliptical cylinder, but is typically a circular cylinder. In this description, the expression “cylindrical” includes not only hollow members, but also solid members.

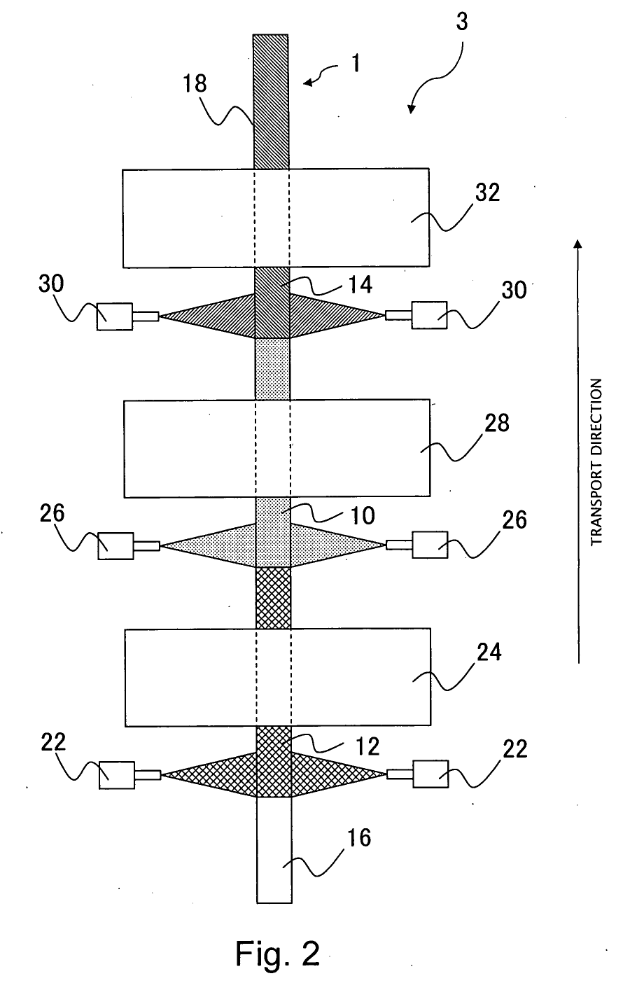

FIG. 2 shows an outline of one example of an apparatus for manufacturing a fuel cell according to an embodiment of the present invention, and the structure of this apparatus is described below. The fuel cell manufacturing apparatus 3 comprises a transport unit such as a winding device (not shown in the diagram), a first spray unit 22, a first drying unit 24, a second spray unit 26, a second drying unit 28, a third spray unit 30, and a third drying unit 32.

In the fuel cell manufacturing apparatus 3 shown in FIG. 2, the first spray unit 22, the first drying unit 24, the second spray unit 26, the second drying unit 28, the third spray unit 30, and the third drying unit 32 are positioned in sequence along the direction of movement of the transport unit. The transport direction of the transport unit may be either vertical or horizontal, although in terms of achieving favorable coating uniformity, vertical transport is preferred.

Next is a description of the operation of both a method for manufacturing a fuel cell, and the fuel cell manufacturing apparatus 3 according to the present invention. As shown in FIG. 2, the current collecting member 16 that functions as the cylindrical support is transported, by the transport unit, sequentially through the first spray unit 22, the first drying unit 24, the second spray unit 26, the second drying unit 28, the third spray unit 30, and the third drying unit 32. In those cases where the transport direction provided by the transport unit is vertical, the current collecting member 16 is transported in a vertical direction, whereas in those cases where the transport direction is horizontal, the current collecting member 16 is transported in a horizontal direction.

First, the first spray unit 22 is used to spray a fuel electrode paste containing a catalyst for the fuel electrode onto the outer surface of the transported current collecting member 16, thus forming a first catalyst layer that functions as the fuel electrode 12.

The current collecting member 16 with the fuel electrode 12 formed thereon is then transported into the first drying unit 24 in a continuous manner, and following drying of the fuel electrode 12, the member is transported towards the second spraying unit 26 in a continuous manner.

Next, the second spray unit 26 is used to spray an electrolyte layer paste containing a perfluorosulfonic acid-based solid polymer electrolyte or the like onto the outer surface of the fuel electrode 12 formed on the transported current collecting member 16, thus forming the electrolyte layer 10.

The current collecting member 16 with the electrolyte layer 10 formed thereon is then transported into the second drying unit 28 in a continuous manner, and following drying of the electrolyte layer 10, the member is transported towards the third spraying unit 30 in a continuous manner.

Next, the third spray unit 30 is used to spray an air electrode paste containing a catalyst for the air electrode onto the outer surface of the electrolyte layer 10 formed on the transported current collecting member 16, thus forming a second catalyst layer that functions as the air electrode 14.

Finally, the current collecting member 16 with the air electrode 14 formed thereon is transported into the third drying unit 32 in a continuous manner, and drying of the air electrode 14 yields a fuel cell 1 with an assembly 18 comprising the fuel electrode 12, the electrolyte layer 10 and the air electrode 14 formed on the outer surface of the current collecting member 16.

In those cases where, within the fuel cell 1, the air electrode 14 is provided as the first catalyst layer on the outer surface of the circular cylindrical current collecting member 16, the electrolyte layer 10 is provided on the outer surface of the air electrode 14, and the fuel electrode 12 is provided as the second catalyst layer on the outer surface of the electrolyte layer 10, the production sequence for the fuel electrode 12 and the air electrode 14 should be reversed from that employed in the above manufacturing method.

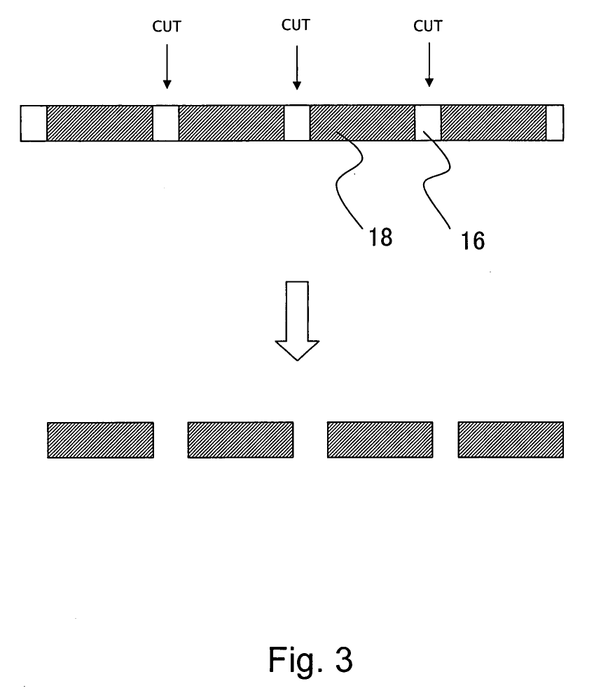

The current collecting member 16 may use a member that is of the same length (typically from 10 to 200 mm) as a typical single cell used as a fuel cell, or alternatively, may use a member that is of a length many times the length of a typical fuel cell single cell. In such cases, as shown in FIG. 3, an assembly 18 that is partitioned into portions can be formed on the outer surface of the current collecting member 16, with a predetermined spacing provided between the portions, and following drying of the second catalyst layer, the current collecting member 16 with the assembly 18 formed thereon can be cut into lengths equivalent to a single cell length, thus yielding a plurality of fuel cell single cells.

In the spraying method mentioned above, either a paste formed by dispersing a catalyst powder for the fuel electrode or air electrode in a solution obtained by dissolving a resin such as a solid polymer electrolyte like Nafion (a registered trademark) in an alcohol-based solvent such as methanol, ethanol or isopropanol, or alternatively, a paste formed by dissolving a solid polymer electrolyte or the like used for the electrolyte layer in an alcohol-based solvent or the like, is used.

The respective concentration levels of the catalyst powder, the solid polymer electrolyte, or the resin or the like within the various pastes may be adjusted to ensure that the catalyst layers (the fuel electrode and the air electrode) and the electrolyte layer are each formed with a uniform film thickness. Although there are no particular restrictions on these concentration levels, in the case of a catalyst layer paste, the catalyst powder preferably accounts for 10 to 50% by weight of the total paste weight, and the resin preferably accounts for 10 to 20% by weight, whereas in the case of the electrolyte layer paste, the solid polymer electrolyte preferably accounts for 5 to 30% by weight of the total paste weight.

The first spray unit 22, the second spray unit 26, and the third spray unit 30 each comprise, for example, a spray nozzle with an emission hole, a paste tank that stores the paste and is connected to the spray nozzle, and a compressor that supplies pressure to the spray nozzle.

In this spraying method, the paste is sprayed onto the current collecting member 16 in the form of a mist, using the spray units. The shape of the atomized liquid sprayed from the spray nozzle may be a fan shape, a filled circle shape, or an annular ring shape, but in order to ensure uniform application, a fan-shaped or filled circle-shaped spray is preferred. Furthermore, the spraying may be conducted using only the liquid pressure of the paste, or the paste may be atomized by mixing with a gas such as air at the time of spraying.

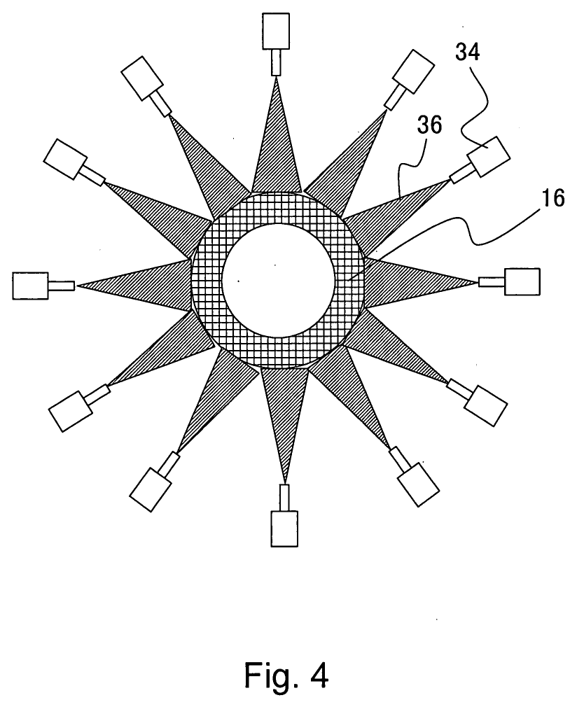

Furthermore, as shown in FIG. 4, in order to improve the film thickness uniformity of the applied films, a plurality of sprayers 34 are preferably used to spray a paste 36 from a plurality of locations positioned around the outer surface of the current collecting member 16. During such spraying, the number and positions of the sprayers 34 are preferably determined so that the sprays from the plurality of sprayers 34 do not overlap. Furthermore, spraying of the paste may also be conducted using either one, or a plurality of sprayers, while the current collecting member 16 is rotated about its own axis, preferably at a constant rate of rotation.

The spraying distance is preferably set within a range from 0.1 to 300 mm. Here, the spraying distance refers to the distance from the outer surface of the current collecting member 16 that represents the spraying target to the tip of the spray nozzle. If this spraying distance is less than 0.1 mm, then spraying problems can arise as a result of the tip of the spray nozzle being too close to the outer surface of the current collecting member 16, whereas if the spraying distance exceeds 300 mm, then the atomized liquid may be scattered too widely over the surrounding area, causing a deterioration in the spraying efficiency.

The spraying pressure is preferably equivalent to a liquid pressure within a range from 0.1 to 200 MPa. If this liquid pressure is less than 0.1 MPa, then the spray may become too weak to enable uniform application of the paste, whereas if the liquid pressure exceeds 200 MPa, then the spray may be too powerful, leading to the atomized liquid being scattered widely over the surrounding area and causing a deterioration in the spraying efficiency.

The diameter of the liquid droplets of paste produced by the spray atomization is preferably within a range from 0.1 to 10 μm, and is even more preferably from 0.1 to 2 μm. In the case of application of the catalyst layers, because it is necessary to form catalytic sites that are as small as possible, the diameter of the liquid droplets is also preferably kept as small as possible. If this diameter of the liquid droplets is less than 0.1 μm, then the liquid droplets can become too small, leading to the mist being scattered and causing a deterioration in the spraying efficiency, whereas if the diameter exceeds 10 μm, the liquid droplets can become too large, making it difficult to achieve a uniform application.

The temperature of the paste during spraying is typically within a range from 20 to 70° C.

The various spraying conditions, including the shape of the atomized liquid spray, the number of sprayers, the locations of the sprayers, the spraying range, the spraying pressure, the diameter of the liquid droplets, and the paste temperature may be determined in accordance with factors such as the desired film thickness and the properties of the paste being sprayed, and should be set with due consideration of how the various conditions affect each other. The same conditions may be employed within the first spray unit 22, the second spray unit 26, and the third spray unit 30, or different conditions may be used within each unit. By appropriate control of these spraying conditions, the fuel electrode 12, the electrolyte layer 10 and the air electrode 14 can be formed in a uniform manner on the outer surface of the current collecting member 16.

There are no particular restrictions on the first drying unit 24, the second drying unit 28, and the third drying unit 32, provided they are capable of drying the formed films. Suitable drying units include hot air dryers, blow dryers, and heat dryers.

Furthermore, the drying temperature within the first drying unit 24, the second drying unit 28, and the third drying unit 32 should be set in accordance with factors such as the boiling point of the solvent used in forming the corresponding paste, and should be set to a temperature that ensures no degradation of the catalysts or electrolyte film or the like. For example, in those cases where methanol, ethanol or isopropanol or the like is used, the temperature is set to a temperature of 80 to 100° C. The same conditions may be employed within the first drying unit 24, the second drying unit 28, and the third drying unit 32, or different conditions may be used within each unit.

In an alternative configuration, instead of employing the first drying unit 24, the second drying unit 28 and the third drying unit 32, at least one drying unit may be provided in a position following film formation using the first spray unit 22, the second spray unit 26 and the third spray unit 30. For example, the fuel electrode 12, the electrolyte layer 10 and the air electrode 14 may be formed consecutively on the outer surface of the current collecting member 16, using the first spray unit 22, the second spray unit 26 and the third spray unit 30 respectively, and the third drying unit 32 then used to conduct drying in a single operation. Furthermore, the first drying unit 24, the second drying unit 28 and the third drying unit 32 may be omitted entirely, so that following consecutive formation of the fuel electrode 12, the electrolyte layer 10 and the air electrode 14 on the outer surface of the current collecting member 16, the product is allowed to dry naturally.

The travel speed of the transport unit is typically set within a range from 1 mm/min to 5×10⁴ mm/min. From the viewpoint of production efficiency, the travel speed is preferably as fast as possible, but in consideration of factors such as the uniformity of the application conducted by the spray units, and the drying properties of the applied films, setting the travel speed to a level exceeding 5×10⁴ mm/min is impractical.

In a fuel cell 1 of FIG. 1 that has been manufactured in the manner described above, if either the current collecting member 16 and the air electrode 14 of the second catalyst layer, or the current collecting member 16 and the current collecting layer formed on the outer surface of the air electrode 14 of the second catalyst layer are connected electrically to an external circuit, and operation is then commenced by supplying raw materials to the fuel electrode 12 and the air electrode 14, the structure can be operated as a fuel cell.

Examples of the raw material supplied to the fuel electrode 12 include reducing gases (fuel gases) such as hydrogen or methane or liquid fuels such as methanol. Examples of the raw material supplied to the air electrode 14 include oxidizing gases such as oxygen or air.

If the fuel cell 1 is operated using hydrogen gas as the raw material supplied to the fuel electrode 12 and air as the raw material supplied to the air electrode 14, then at the fuel electrode 12, hydrogen ions (H⁺) and electrons (e⁻) are generated from the hydrogen gas (H₂) via a chemical reaction represented by the equation shown below.

2H₂→4H⁺+4e⁻

The electrons (e⁻) travel from the current collecting member 16, through the external circuit, and if necessary through the current collecting member provided on the outer surface of the air electrode 14, before reaching the air electrode 14. At the air electrode 14, the oxygen (O₂) within the supplied air, the hydrogen ions (H⁺) that have passed through the electrolyte layer 10, and the electrons (e⁻) that have traveled through the external circuit to reach the air electrode 14 generate water via a reaction represented by the equation shown below.

4H⁺+O₂+4e⁻→2H₂O

In this manner, chemical reactions occur at both the fuel electrode 12 and the air electrode 14, thereby generating an electrical charge and enabling the structure to function as an electric cell. Because the component discharged from this series of reactions is water, a clean electric cell is achieved.

As described above, by employing an apparatus for manufacturing a fuel cell and a method for manufacturing a fuel cell according to the present embodiment, either the forming each of the layers by spraying the outer surface of the cylindrical support are conducted in a continuous manner, or alternatively, the forming each of the layers by spraying and the subsequent drying are all conducted in a continuous manner. As a result, favorable film thickness uniformity is achieved for the first catalyst layer, the electrolyte layer and the second catalyst layer, and each layer can be produced in a continuous manner, meaning fluctuations in performance between individual single cells can be reduced. In addition, by using this manufacturing apparatus and manufacturing method, the number of steps required for fabrication of the fuel cells can be reduced, which enables a reduction in costs. Furthermore, in a conventional immersion method, because the support is immersed directly in, and then removed from, the material solutions, the catalyst layers are also formed in locations where these layers are unnecessary (such as the edges of the support), and these unnecessary portions of the catalyst layers must be removed in subsequent steps. However, in an apparatus for manufacturing a fuel cell and a method for manufacturing a fuel cell according to the present embodiment, because spraying can be conducted intermittently, the spraying can be halted in those locations where the catalyst layers are unnecessary, and consequently a subsequent step for removing unnecessary portions is not required, meaning the number of steps can be reduced. This type of intermittent application can only be conducted using a spraying method.

Furthermore, by using a current collecting member as the cylindrical support, the assembly can be manufactured as an integrated unit with the current collecting member. As a result, compared with conventional methods in which following manufacture of the assembly, carbon fiber or the like is inserted into the tube as a current collecting member, there is no danger of scratching the electrode on the inside of the tube, and the current collecting member can be more readily provided on the assembly. Furthermore, compared with methods in which the current collecting member is inserted following manufacture of the assembly, the closeness of the adhesion between the current collecting member and the assembly is improved, enabling a reduction in the cell resistance during power generation. Furthermore, in an apparatus for manufacturing a fuel cell and a method for manufacturing a fuel cell according to the present embodiment, provided the film formation and drying for each layer are conducted consecutively, seepage of the paste into the current collecting member caused by having an overly long time period between the film formation and the drying can be suppressed, meaning a uniform assembly can be formed on the current collecting member.

With fuel cells according to the present embodiment, the desired current and voltage levels can be obtained by combining a plurality of individual cylindrical fuel cells (single cells), and connecting them together in series. Furthermore, a plurality of individual cylindrical fuel cells (single cells) may also be combined and connected together in parallel.

Because a fuel cell according to an embodiment of the present invention has a simple structure that can be readily reduced in size and weight, it can be used as a small power source for portable equipment such as mobile phones and portable computers; and as a power source for automobiles.

1. A method for manufacturing a cylindrical fuel cell having a first catalyst layer, an electrolyte layer and a second catalyst layer, comprising:
forming the first catalyst layer on an outer surface of a cylindrical support by a spraying method,
forming the electrolyte layer on the first catalyst layer by a spraying method, and
forming the second catalyst layer on the electrolyte layer by a spraying method, wherein
each of the forming is conducted in a continuous manner.

2. The method for manufacturing a fuel cell according to claim 1, further comprising:
drying the formed first catalyst layer following the forming the first catalyst layer,
drying the formed electrolyte layer following the forming the electrolyte layer, and
drying the formed second catalyst layer following the forming the second catalyst layer, wherein
each of the forming and drying is conducted in a continuous manner.

3. The method for manufacturing a fuel cell according to claim 1, wherein
the spraying method is conducted by spraying a paste onto a plurality of locations on the outer surface of the cylindrical support.

4. The method for manufacturing a fuel cell according to claim 1, wherein
the cylindrical support with each of the layers formed thereon is cut to yield a plurality of fuel cell single cells.

5. The method for manufacturing a fuel cell according to claim 1, wherein
the cylindrical support is a conductive porous member.

6. An apparatus for manufacturing a cylindrical fuel cell having a first catalyst layer, an electrolyte layer and a second catalyst layer, comprising:
a transport unit that transports a cylindrical support,
a first spray unit that sprays a paste for the first catalyst layer onto an outer surface of the cylindrical support to form the first catalyst layer,
a first drying unit that dries the formed first catalyst layer,
a second spray unit that sprays a paste for the electrolyte layer onto the dried first catalyst layer to form the electrolyte layer,
a second drying unit that dries the formed electrolyte layer,
a third spray unit that sprays a paste for the second catalyst layer onto the dried electrolyte layer to form the second catalyst layer, and
a third drying unit that dries the formed second catalyst layer.

7. The apparatus for manufacturing a fuel cell according to claim 6, wherein each of the spray units comprises a plurality of sprayers.

8. The apparatus for manufacturing a fuel cell according to claim 6, wherein
the cylindrical support is a conductive porous member.
